(19) United States
(12) Patent Application Publication
(10) Pub. No.: US 2015/0149307 A1
(43) Pub. Date: May 28, 2015

(54) LOCATION-BASED ORDERING

(71) Applicant: Harsimrat Thukral, Vancouver (CA)

(72) Inventor: Harsimrat Thukral, Vancouver (CA)

(21) Appl. No.: 14/552,281

(22) Filed: Nov. 24, 2014

Related U.S. Application Data
(60) Provisional application No. 61/907,651, filed on Nov. 22, 2013.

(51) Int. Cl. G06Q 30/06; H04W 4/00; H04L 29/06; G06Q 50/12; H04W 12/06

(52) U.S. Cl. CPC G06Q 30/0635; G06Q 50/12; H04W 12/06; H04L 63/0876; H04W 4/008; H04W 84/12
USPC 705/15

(57) ABSTRACT

Some embodiments provide a novel process for ordering items available in a menu or specials at a particular location. In some embodiments, the location can be any one of a table in a restaurant, a lounge, a bar, a hotel room with room service, a seat in a sports arena, and any other location which is served by a business. In some embodiments, the process operates by scanning one of a QR code, a bar code, and an NFC tag available on a designated order scan location. In some embodiments, the designed order scan location is one of a seat, a table, and a hotel room placard or sticker. In some embodiments, the process is implemented as a software application that runs on a mobile computing device. In some embodiments, the software application is downloaded if not previously available on the mobile computing device and that locations menu is opened by identifying the location from the scanned code and is tailored based on time of day or further customized to users language preference or their dietary requirements.

### CLAIM OF BENEFIT TO PRIOR APPLICATION

This application claims benefit to U.S. Provisional Patent Application 61/907,651, entitled “SYSTEM AND PROCESSES FOR DYNAMICALLY SETTING PRICE BASED ON BUYING HISTORY,” filed Nov. 22, 2013. The U.S. Provisional Patent Application 61/907,651 is incorporated herein by reference.

### BACKGROUND

Embodiments of the invention described in this specification relate generally to the hospitality business, and more particularly, ordering items provided in hospitality businesses.

Many people frequently order items from a menu or as provided in a restaurant, lounge, bar, etc. This often requires a person to be waited on in order to make a simple order. This is problematic for many people who may be in a hurry, or who already know what they would like to order without looking at a menu. To assist those who are often hurried, many people have smart phones, tablet computing devices, mobile communication devices, or other mobile computing devices (hereinafter referred to collectively as “mobile computing devices”). However, mobile computing devices have not been used, to date, in a way to speed up ordering.

Therefore, what is needed is a way to order items using a mobile computing device without having to wait for service.

### BRIEF SUMMARY

Some embodiments of the invention provide location-based ordering of items available in a menu or specials offered at a location. In some embodiments, a process provides ordering of items by scanning a code associated with a location and selecting an item from a display of items offered at the location. In some embodiments, the location particularly identifies a delivery location at which an ordered item can be delivered. A location can be any one of a table in a restaurant, a lounge, a bar, a hotel room with room service, a seat in a sports arena and any other location which is served by a business. In some embodiments, the process operates by scanning one of a QR code, a bar code, and an NFC tag available on a designated order scan location. In some embodiments, the designed order scan location is one of a seat, a table, and a hotel room placard or sticker. In some embodiments, the process is implemented as a software application that runs on a mobile computing device. The mobile computing device is one of a smart phone, a tablet computing device, a mobile communication device, and a hand-held computing device. In some embodiments, the software application is downloaded if not previously available on the mobile computing device and the locations menu is opened by identifying the location from the scanned code and is tailored based on time of day or further customized for language preference or dietary requirements.

Some embodiments also provide a location mapping process that allows a set of locations to be mapped according to a unique scan code positioned at each location. In some embodiments, the location mapping process includes identifying a set of locations to be mapped, registering each location to be mapped, associating each registered location with a unique scan code, and mapping the registered locations to a display map for viewing on a display screen of a computing device.

### BRIEF DESCRIPTION OF THE DRAWINGS

Having thus described the invention in general terms, reference is now be made to the accompanying drawings, which are not necessarily drawn to scale, and which show different views of different example embodiments, wherein:

FIG. 1 conceptually illustrates a process in some embodiments for ordering items available in a menu at a location associated with a registered scan code.

FIG. 2 conceptually illustrates a registered scan code associated with a venue location in some embodiments while the registered scan code is being scanned by an exemplary mobile computing device.

FIG. 3 conceptually illustrates an example of a menu that is displayed after a registered scan code associated with a venue location is scanned.

FIG. 4 conceptually illustrates a detailed location-based item ordering process for scanning a tag at a location of a venue and ordering one or more items from a menu in some embodiments.

FIG. 5 conceptually illustrates a location mapping process for mapping a set of locations based on a set of unique scan codes positioned at a set of physical locations of a venue in some embodiments.

FIG. 6 conceptually illustrates an example of location mapping for a set of seats and a table at a venue.

FIG. 7 conceptually illustrates an electronic system with which some embodiments of the invention are implemented.

FIG. 8 conceptually illustrates a schematic view of an architecture of a location-based ordering and fraud mitigation system in some embodiments.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.
I. Location-Based Ordering of Items

Some embodiments provide location-based ordering of items available in a menu or specials offered at a location. A location can be any one of a table in a restaurant, a lounge, a bar, a hotel room with room service, a seat in a sports arena and any other location which is served by a business.

In some embodiments, a process provides ordering of items by scanning a code associated with a location and selecting an item from a display of items offered at the location. In some embodiments, the location particularly identifies a delivery location at which an ordered item can be delivered. In some embodiments, the process operates by scanning a tag. For purposes of this specification, a tag can be any of a QR code, a bar code, an NFC tag, or other such encoded symbol or recognizable data that may be available on a designated order scan location. In some embodiments, the designed order scan location is one of a seat, a table, and a hotel room placard or sticker. In some embodiments, the process is implemented as a software application that runs on a mobile computing device. The mobile computing device is one of a smart phone, a tablet computing device, a mobile communication device, and a hand-held computing device. In some embodiments, the software application is downloaded if not previously available on the mobile computing device and the locations menu is opened by identifying the location from the scanned code and is tailored based on time of day or further customized for language preference or dietary requirements.

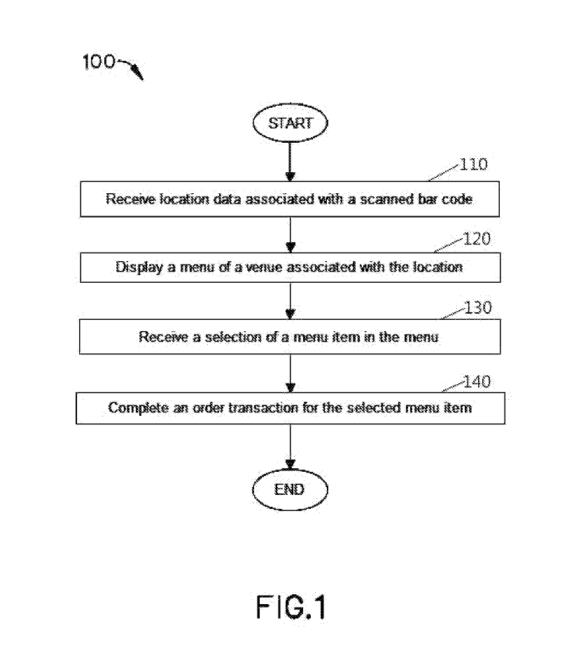

By way of example, FIG. 1 conceptually illustrates a process 100 for ordering items available in a menu at a location associated with a registered scan code. The process 100 is performed by a computing device that receives a scan code from a person who may have used a mobile computing device to capture an image of the scannable location-based code. As shown in this figure, the process 100 starts when the location-based scan code data is received from the mobile device. Thus, the process 100 receives (at 110) location data associated with the scanned bar code. Next, the process 100 displays a menu of a venue associated with the location. In some embodiments, the scanned bar code is transmitted to the selected venue. For example, a person may wish to order something at a restaurant, but being in a hurry, may wish to expedite the order as quickly as possible. Thus, the person may simply scan a code that is available at a service location of the restaurant (e.g., a chair, a table, etc.), and then get the menu displayed on the mobile device in order to make one or more food/drink selections from the menu.

After the menu is displayed, the process 100 then receives (at 130) a selection of a menu item to order. The person doing the ordering may select multiple items is so inclined. In some embodiments, after the person makes all item selections for an order, the process 100 completes (at 140) an order transaction for the selected menu item(s). Then the process 100 ends.

Some embodiments are implemented for use in a restaurant. In these embodiments, a customer may walk into the restaurant and be seated by a Maître d or self-seated. The customer may see the tag on the table and scan it with a mobile computing device and see the customized menu based on their preferences if available, otherwise see the regular menu for that day with any available specials. If there are multiple people in the party, they can order individually for themselves or for the whole table and can also be based on finally how many people are paying for the bill. Once the order is placed; it is sent to the kitchen using multiple techniques that can vary from restaurant to restaurant. Once ordered, the ordering system stays open and the customers can keep on ordering until they finally decide to be done or order in multiple chunks and choose to pay for each chunk and that can be directly done from the mobile computing device or through the server. The payment from the mobile computing device can be made in various ways. For example, a first customer might use a virtual wallet, a second customer might use a different virtual wallet, a third customer might use yet another virtual wallet, and a fourth customer might pay by credit card every time or pay using carrier billing. A customer may tweet about the food they had or post reviews on the social networks. There can be some kind of incentive provided to the customer to put these reviews up on social sites.

Some embodiments are implemented for use in a hotel. For example, after a person checks into a hotel, the customer scans the tags which are available in multiple locations in the hotel room. Then the tag is scanned—which can be again NFC, QR code, bar code or any such variant capable of holding some information. The app is opened if available on the mobile computing device otherwise the user may be re-directed to download the app from app stores. Once the customer places the order and it's sent directly to the hotel's kitchen, then the food is delivered directly to the room. The hotel can allow payment options for adding the bill to the room charges or make the payment from the credit card or through various other techniques mentioned above.

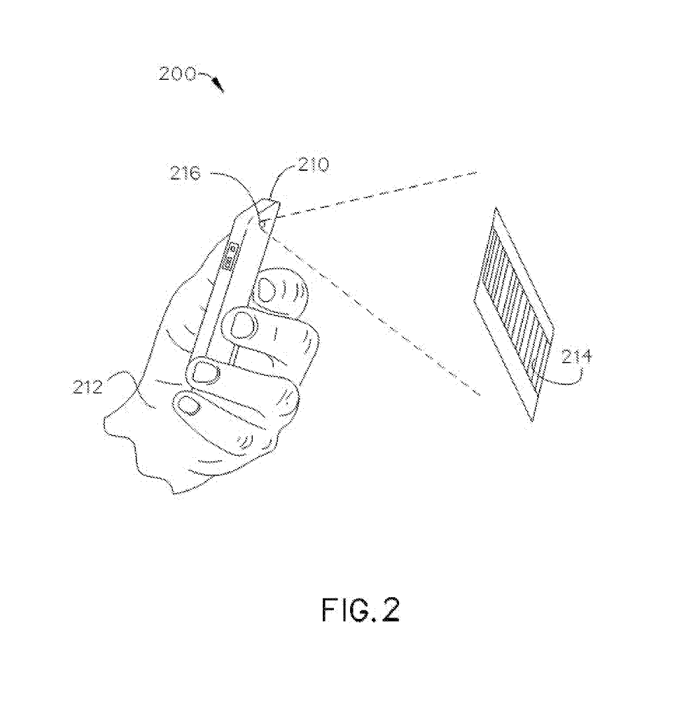

By way of example, FIG. 2 conceptually illustrates a registered scan code (or “tag”) associated with a venue location while the registered scan code is being scanned 200 by an exemplary mobile computing device 210. In this example, the registered scan code may be one of the locations in a hotel room after a person checks into the hotel. As shown in this figure, the scanning 200 of a registered scan code 214 is being performed by operation of a person 212 using an image capture device 216 of the mobile computing device 210.

While the tag appears to be unfixed to any location in FIG. 2, a person skilled in the art would understand that the tag may be affixed to any of several positions or locations which can be identified and mapped in order to obtain ordering service. For example, a tag might be placed on a wall inside the hotel room, on the inside of the door of the hotel room, in a lobby or lounge wall of the hotel, etc., thereby allowing the person to scan the tag in the hotel and make an order nearby the tag location (e.g., room service, a lounge or restaurant order, etc.). Also, the tag in this example is shown as a scannable bar code, yet the registered scan code may be any of the exemplary scan codes described in this specification.

In some embodiments, the key card of a hotel room (when a person is already checked-in to the hotel and was given a key card for the room) may have a QR code or an NFC tag which enables the hotel guest to order from the hotel room, bar, or lounge menu if the hotel guest is physically present in the hotel room, bar, or lounge, respectively, as the security device can identify where the hotel guest is and the bill can be directly charged to the room account. In some cases, this is an additional service which may add extra service charges for patrons of the hotel.

Usage in a sports arena is possible in some embodiments. In these embodiments, the customer has taken the seat in the stadium or sports arena. The type of engagement in the arena can be a sports game, a concert, or any other related event in a large space (stadium, arena, concert venue, etc.). The customer can scan the tag which is available on their seat. In some cases the tag may not be available to scan. For instance, there is high possibility that tag is unavailable as each and every seat is hard to retrofit with the tag (bar code, NFC or QR code). Likewise, tags that are placed on the seats may be obscured from markings or scratches, making it difficult or impossible to scan. In that case, when the tag is unavailable (it's also applicable to all above cases, where the mobile computing device is unable to read the tag), the person can open the application (or download the app if not already installed) and look for the seat in the sports arena or concert hall which can be searched or picked from the available list which may have been narrowed by identifying user's location. The seat number can be obtained by various other methods like partnering with StubHub or Ticketmaster or any other ticket issuing companies. Once the location is selected and the user manually inputs their seat location (only required in those cases when a tag is missing or the wrong tag is associated with the seat). User orders any of several items that may be offered for sale. For instance, the customer may purchase merchandise, such as jerseys, hats, and other items, or may purchase edible items, such as food or drinks, and then have to pay right away before the order will be sent over to the kitchen or the server. The business in this case sports arena may allow for customers to order and then pay the server directly in cash; in that case they establishment takes responsibility if the order was not made by the responsible party.

In some embodiments, usage in lounge or bar is supported. For example, in bars people move around a lot and do not necessarily stay in a fixed location or area. Therefore, attaching codes on seats does not necessarily work in the same sense that it works in a restaurant or other venue with a defined seating location. However, tags in a bar or lounge can still be attached to some tables, which can be occupied by different groups of individuals. In that case, a user can scan the tag if available on the table or manually open the app and follow the steps above to get to the menu.

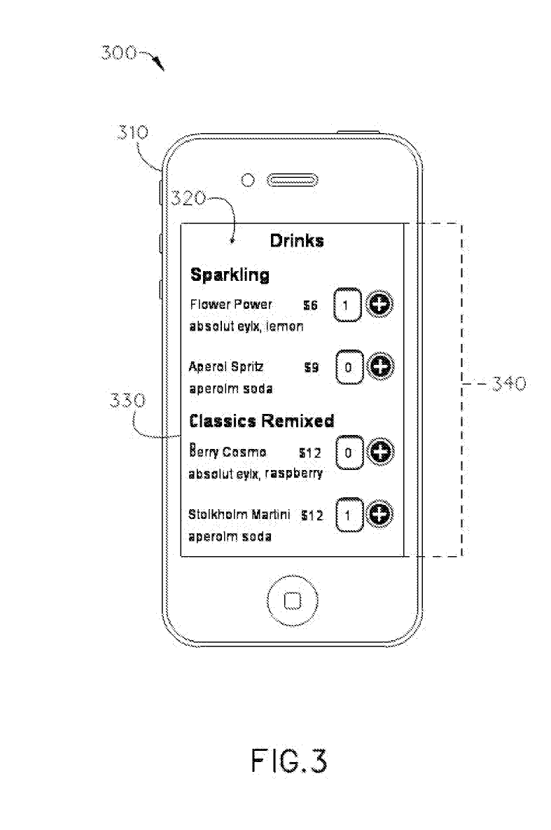

By way of example, FIG. 3 conceptually illustrates an example 300 of a menu that is displayed after a registered scan code associated with a venue location is scanned. As shown in this figure, the example 300 of a menu 340 is displayed in a graphical user interface (GUI) 320 on a display screen 330 of a mobile computing device 310. The GUI 320 allows the person to interact with the menu 340 to make selections of items (e.g., different drinks that are available to order). The display screen 330 may be a touch-sensitive screen to allow the person to interact with the GUI 320 by single or multiple touch interactions, or by way of a stylus or other interactive touch-screen device. Alternatively, the person may interact with the GUI 320 via input device, such as a connected mouse, buttons for navigation and selection, etc.

By using the menu 340 that is displayed on the mobile computing device 310, the user can select and order drinks. If the scan code was scanned for a table at the lounge or bar, then when the order is delivered to the table, the user can make payment in any of several ways as noted above. For instance, once the drinks are received, the user may pay by mobile computing device or pay the server directly. Also, when orders are delivered to a table at which multiple parties are seated, a simple call-out of the customer's name may be required.

In a crowded bar, people generally must go to the bartender and order drinks. It can be incredibly difficult to get the bartender's attention and is a great hassle to wait in line to order and then pay for the same. Yet in the crowded bar scenario, users will be able to order drinks from the mobile computing device and pick those up at the bar directly by either paying to the bartender or paying through the mobile computing device. The user will be able to open the bar tab; by authorizing hold for certain amount on the credit card and at the end of the night, that payment can be processed, which is controlled by each individual business, to allow the opening of tab or not.

In some embodiments, pre-ordering from restaurants is supported. In these embodiments, restaurant customers who have to make a reservation at the restaurant can pre-order food from the menu. Since the restaurant customer will be at the restaurant at the time designated by the reservation, the restaurant staff will be able to prepare the ordered food so that it is ready to serve upon arrival at the restaurant by the restaurant customer. This is similar to how the restaurant staff prepares the table for the restaurant customer prior to seating the restaurant customer. The difference now is that the customer may pre-order meals from the menu and have them ready to be served by the time of arrival. This speeds up downtime for busy customers and it helps restaurants to know in advance in order to better accommodate restaurant guests.

In some embodiments, a set of general steps are involved in the process for scanning and determining customer presence, including the following steps:
1. A user of a mobile computing device scans a tag.
2. Table and restaurant information is read from the tag (background task).
3. User is presented with the menu or choices to order.
4. User selects the desired items and quantities.
5. User places the order.
6. Payment option is selected by the user

For making payment, the options for the user include at least the following payment options: (i) the user can pay for the order (i.e., now), (ii) the user can leave the order open and pay after ordering multiple times (i.e., keeping an order open to get many items), and (iii) the user can pay the server at the end (e.g., keeping an “open tab” and paying when leaving the venue).

Also, in some embodiments the process at this point may determine whether the mobile computing device of the user is at the indicated location. If the process is successful in determining the user's present proximity to the venue, then the order is placed. In the case when the user is not found at the location, the order-fulfilling establishment (e.g., restaurant, bar, etc.) has discretion to allow the order to go through or not. Also, the establishment can override any order.

Another example includes a general step-by-step process for usage by restaurants.
1. Customer/User walks into a Restaurant/Business.
2. Maître' d has a mobile computing device, when she seats the customers down; she allows the table to order through their mobile computing device (opens a virtual table to allow virtual ordering).
3. The restaurant can have it setup where the above step is not required and every table is just allowed to order virtually.
4. As soon as the customer order is placed, it is either sent to the EPOS system which is connected in the restaurant or on the mobile device which is in the kitchen and runs some custom app which can detect incoming orders.
5. The kitchen prepares the food and is delivered to the customer.

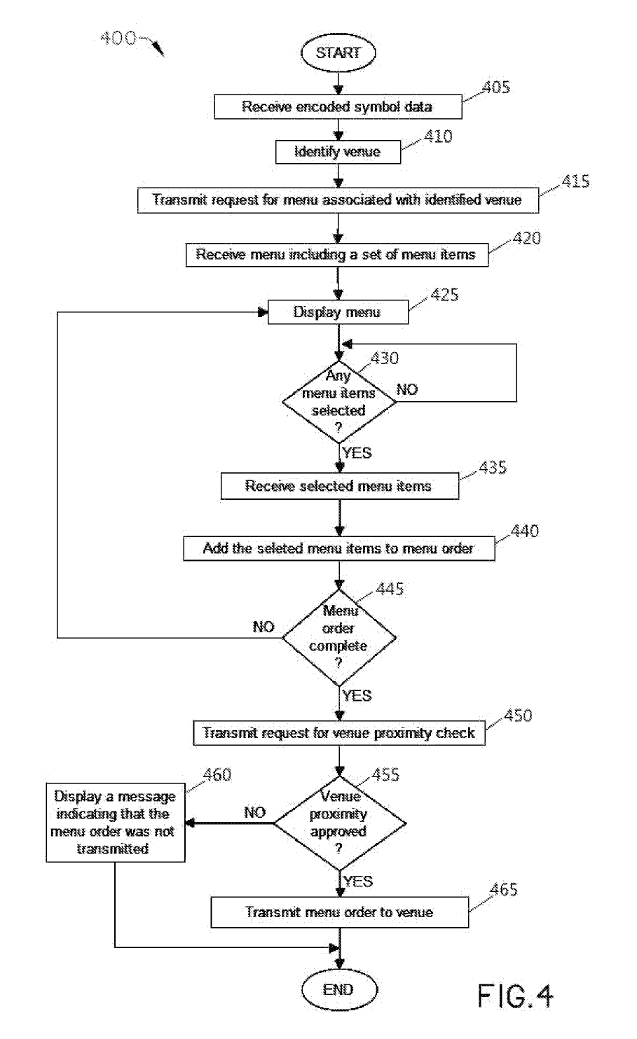

By way of example, FIG. 4 conceptually illustrates a detailed location-based item ordering process 400 for scanning a tag at a location of a venue and ordering one or more items from a menu in some embodiments. As shown in this figure, the process 400 receives (at 405) encoded symbol data. For instance, a user of a mobile computing device may have scanned a bar code, a QR code, or some other encoded symbol a particular venue location or as a pre-order not necessarily tied to a specific location of the user. Regardless of the user's specific location (which could be stationary at a particular venue or could be en route to the venue), the process 400 next identifies (at 410) the venue which is associated with the encoded symbol data. For example, the mobile computing device of the user may perform a look-up of venues in order to find the particular venue associated with the encoded symbol data scanned in the present case. Alternatively, the mobile computing device may transmit a request to a third party for venue information which is associated with the scanned encoded symbol data.

In some embodiments, the process 400 then receives (at 420) a menu that includes a set of menu items. The process 400 next displays (at 425) the menu. For instance, once the menu is received, the process may display the menu (and a set of menu items) on the display screen of the user's mobile computing device.

After displaying the menu, the process 400 then determines (at 430) whether any menu items are selected from the displayed menu. If no items are selected, then the process 400 returns to 430 to continue determining whether items have been selected. Otherwise, when menu items have been selected, the process 400 then receives (at 435) the selected menu items. The process of some embodiments also adds (at 440) the selected menu items to the menu order. The process 400 then determines (at 445) when the menu order is complete. When the menu order is not complete, the process 400 transitions back to 425 to display the menu, as described above.

On the other hand, when the process 400 determines that the menu order is complete, the process 400 then transmits (at 450) a request for a venue proximity check. In some embodiments, the user can order items from a distance away from the venue by simply scanning a code which may appear in a magazine or other periodical, or by scanning another symbol which brings up the menu of the venue, regardless of the user's location in relation to the venue. If the proximity check indicates that the user is not proximate to the location of the venue, then in some embodiments, the order may be put on hold. In some cases, when the user is within a specified threshold distance from the venue, the order may proceed.

Thus, the process 400 determines (at 455) whether the proximity check is approved or not. When the user is beyond the threshold distance, then the process 400 determines that the proximity check is not approved, and displays (at 460) a message indicating that the menu order was not transmitted, and then the process 400 ends. On the other hand, in some embodiments, when the proximity check is approved, the process 400 then transmits (at 465) the menu order to the venue. The process 400 then ends.

Some embodiments provide protection against fraud. Because this technology makes it very simple and easy for customers to order and for and hospitality business owners to effectively serve their patrons, a number of inherent risks come to the forefront. The bigger challenge here in terms of risk is that QR code, bar code, or NFC tags which are attached to the table can be misplaced and even if you are not at the said establishment, the tag can be scanned and the ordering will get enabled and in busy restaurants or bars would be hard to identify the customer who ordered is actually at the establishment or not. Any bad orders have a potential of cutting into establishments bottom line.

To mitigate the above risk, some embodiments include a device that determines whether an ordering customer is present in a particular location. For example, this device may listen for anonymous Wi-Fi signals transmitted by the mobile computing device of a user and capture non-identifiable user information such as MAC ID. Single or multiple devices can be deployed in any given location in order to adequately cover the entire area. For example, a lounge may have one device, while a stadium may have several devices deployed. Furthermore, when the user first downloads the app, they are verified by their mobile number and only after successful verification are they allowed to use the app for actual ordering. During the sign-up and verification process, with the user's permission, the MAC ID is captured and stored in the cloud database.

When the user tries to order by scanning the tag and before the order is sent to kitchen, they are verified against the above device, that if they are in the vicinity by using the MAC ID and the signal strength. Based on the signal strength of the customer's mobile computing device, our algorithms come up with a likelihood number which ranges from 1-5. Higher the number, more likelihood that you are in the establishment. If the number falls below 2.5, we try to use customer co-ordinates to identify and increase the score, so that order is allowed to go through without any interruptions. If the score still doesn't improve, the customer is notified to please approach the restaurant staff and they can allow the order to go through as we have given them technology to override the system. The device is the part of the package to hotels, restaurants, and all other establishments. When setting up for the first time, they can depend on the default likelihood number or change the default to be lower or higher. The likelihood number can be changed anytime by the individual establishment.
II. Location Mapping Process

Some embodiments also provide a location mapping process that allows a set of locations to be mapped according to a unique scan code positioned at each location. In some embodiments, the location mapping process includes identifying a set of locations to be mapped, registering each location to be mapped, associating each registered location with a unique scan code, and mapping the registered locations to a display map for viewing on a display screen of a computing device.

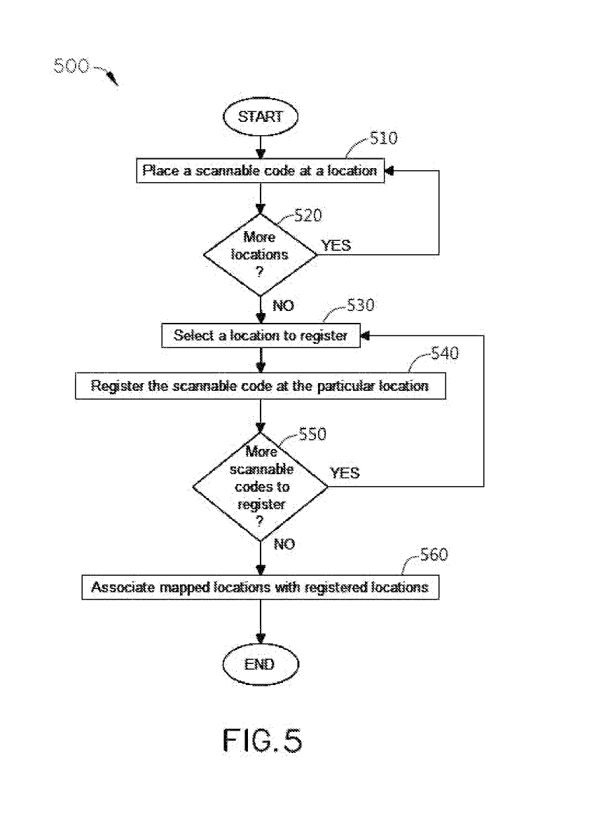

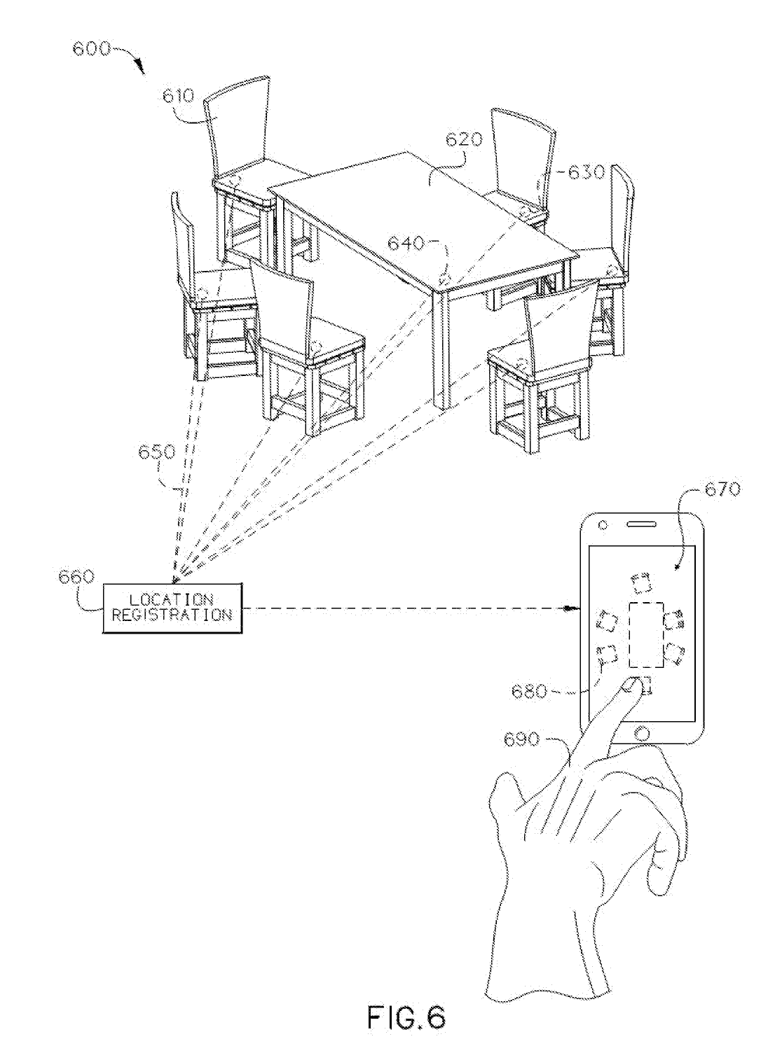

By way of example, FIG. 5 conceptually illustrates a location mapping process 500 for mapping a set of locations based on a set of unique scan codes positioned at a set of physical locations of a venue in some embodiments. The steps of the process 500 are described by reference to FIG. 6, which conceptually illustrates an example of location mapping 600 for a set of seats and a table at a venue. Referring to FIG. 5, the process 500 begins after a set of tags have been positioned at locations and are prepared to be registered and mapped. Thus, the process 500 places (at 510) a scannable code (i.e., “tag”) at a location. The process 500 determines (at 520) whether there are more locations to place tags. When all locations include tags, the process 500 transitions to 530 to select a location to register, which is described in further detail below. However, when the process determines that there are more locations to tag, the process 500 returns to 510 to place another tag at another location.

Referring to FIG. 6, each chair 610 in a set of six chairs is positioned at a location around a table 620. In order for the location of each chair 610 to be recognized, a tag 630 is positioned on each chair 610. Similarly, a tag 640 is positioned on the table 620. Thus, a person seated at a particular chair 610 can make an individual order by scanning the tag 630 positioned on the particular chair 610 at which the person is seated. Alternatively, a group of people seated in the six chairs 610 may order several items collectively and place the order in association with the tag 640 that is positioned on the table 620 (i.e., a group order).

While the example presented in FIG. 6 illustrates tag placement on individual chairs and tables, a person skilled in the art would understand that a tag could be placed in any location that can be mapped and which allows a person to scan the tag. For example, a tag might be placed on a wall inside or outside of an establishment, thereby allowing a person to scan the tag and make an order nearby the tag location.

Turning back to FIG. 5, the process 500 of some embodiments selects (at 530) a location to register. The process 500 then registers (at 540) the tag code at the selected location. The process 500 then determines (at 550) whether there are more locations remaining to be registered. When there are more locations to register, the process 500 returns to 530 for selection of the next location to register. For example, a person setting up a seating map in a restaurant (e.g., the restaurant manager or Maître' d) may need to register several new chair locations and/or table locations, and then map them to displayable graphical elements in a graphical user interface (GUI). On the other hand, when there are no more locations remaining to register, the process 500 of some embodiments associates (at 560) the mapped locations with registered locations of the tags.

As shown in FIG. 6, location registration 660 occurs in relation to each of the six chairs by scanning 650 (conceptually shown by dashed lines) the tag 630 positioned on each chair 610 and the tag 640 positioned on the table 620. A set of graphical elements 680 are displayed in a map 670 which a user 690 is interacting with in order to register each scanned chair tag 630 and table tag 640 in relation to their particular locations in the venue. In this way, all the locations can be identified quickly so that a customer at a venue can order items quickly without waiting for individual ordering service.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.
III. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

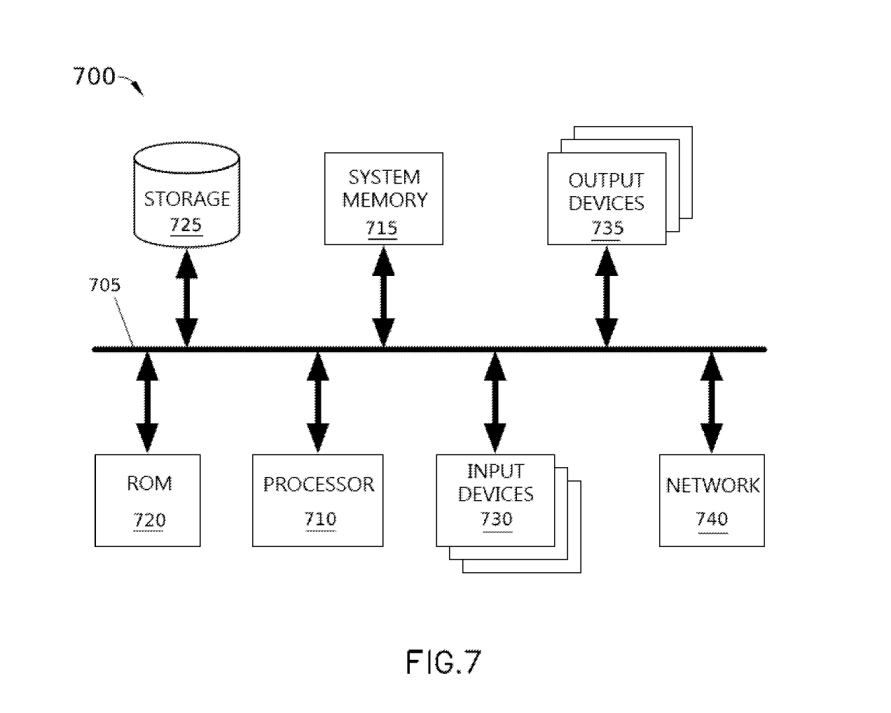

FIG. 7 conceptually illustrates an electronic system 700 with which some embodiments of the invention are implemented. The electronic system 700 may be a computer, phone, PDA, or any other sort of electronic device. Such an electronic system includes various types of computer readable media and interfaces for various other types of computer readable media. Electronic system 700 includes a bus 705, processing unit(s) 710, a system memory 715, a read-only 720, a permanent storage device 725, input devices 730, output devices 735, and a network 740.

The bus 705 collectively represents all system, peripheral, and chipset buses that communicatively connect the numerous internal devices of the electronic system 700. For instance, the bus 705 communicatively connects the processing unit(s) 710 with the read-only 720, the system memory 715, and the permanent storage device 725.

From these various memory units, the processing unit(s) 710 retrieves instructions to execute and data to process in order to execute the processes of the invention. The processing unit(s) may be a single processor or a multi-core processor in different embodiments.

The read-only-memory (ROM) 720 stores static data and instructions that are needed by the processing unit(s) 710 and other modules of the electronic system. The permanent storage device 725, on the other hand, is a read-and-write memory device. This device is a non-volatile memory unit that stores instructions and data even when the electronic system 700 is off. Some embodiments of the invention use a mass-storage device (such as a magnetic or optical disk and its corresponding disk drive) as the permanent storage device 725.

Other embodiments use a removable storage device (such as a floppy disk or a flash drive) as the permanent storage device 725. Like the permanent storage device 725, the system memory 715 is a read-and-write memory device. However, unlike storage device 725, the system memory 715 is a volatile read-and-write memory, such as a random access memory. The system memory 715 stores some of the instructions and data that the processor needs at runtime. In some embodiments, the invention's processes are stored in the system memory 715, the permanent storage device 725, and/or the read-only 720. For example, the various memory units include instructions for processing appearance alterations of displayable characters in accordance with some embodiments. From these various memory units, the processing unit(s) 710 retrieves instructions to execute and data to process in order to execute the processes of some embodiments.

The bus 705 also connects to the input and output devices 730 and 735. The input devices enable the user to communicate information and select commands to the electronic system. The input devices 730 include alphanumeric keyboards and pointing devices (also called “cursor control devices”). The output devices 735 display images generated by the electronic system 700. The output devices 735 include printers and display devices, such as cathode ray tubes (CRT) or liquid crystal displays (LCD). Some embodiments include devices such as a touchscreen that functions as both input and output devices.

Finally, as shown in FIG. 7, bus 705 also couples electronic system 700 to a network 740 through a network adapter (not shown). In this manner, the computer can be a part of a network of computers (such as a local area network (“LAN”), a wide area network (“WAN”), or an intranet), or a network of networks (such as the Internet). Any or all components of electronic system 700 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.
IV. Location-Based Ordering and Fraud Mitigation System

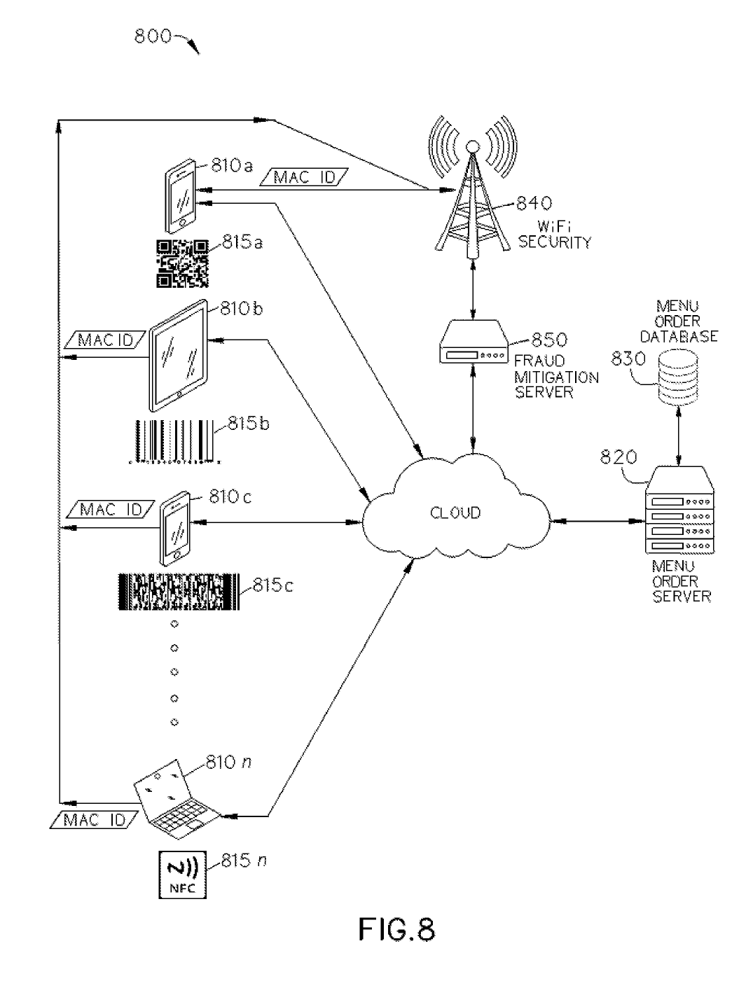

FIG. 8 conceptually illustrates a schematic view of an architecture of a location-based ordering and fraud mitigation system 800 used to order items via scanned tag and deliver to a customer in proximity of a venue from which the items are ordered. As shown in this figure, the location-based ordering and fraud mitigation system 800 includes a plurality of mobile computing devices 810a-810n, a plurality of tags 815a-815n, a menu/order server 820, a menu/order database 830, a WiFi security component 840, and a fraud mitigation server 850. The menu/order server 820 in some embodiments of the location-based ordering and fraud mitigation system 800 receives requests for menu items and completes orders. In some embodiments, the menu/order server 820 also finalizes transactions. Thus, when a customer uses a mobile computing device (such as one of the mobile computing devices 810a-810n) to scan a tag (such as one of the tags 815a-815n), the menu/order server 820 will transmit a menu to the mobile computing device for display on a display screen of the mobile computing device (such as, for example, the menu shown in the graphical user interface described by reference to FIG. 3). As the customer interacts with the menu and selects items to order, the menu/order server 820 receives the orders and determines the location of the customer based on the tag which was scanned by the customer's mobile computing device. In this way, delivery of the ordered items can occur swiftly.

In some embodiments, the menu/order database stores different menus for different times of the day or different seasons of the year. Any type of variable may play into the variations of menus/order lists which are transmitted to mobile computing devices of customers and may depend on one or more of several different factors. A person skilled in the art would understand that such factors do not further limit the underlying functionality of the location-based ordering and fraud mitigation system 800.

In addition, the menu/order database 830 in some embodiments stores records of all orders and completed transactions. In some embodiments, the menu/order database 830 stores tag mapping data so that delivery of items can be mapped on mobile computing devices or other devices of delivery personnel responsible for delivering ordered items to customers.

In some embodiments, the WiFi security component 840 and the fraud mitigation server 850 provide hardware authentication and validation based on physical proximity of a mobile computing device used to scan a tag and make a subsequent order. Thus, in some embodiments of the location-based ordering and fraud mitigation system 800, all of the mobile computing devices 810a-810n transmit a unique physical hardware ID, such as a MAC ID, to the Wifi security component 840 for processing by the fraud mitigation server 850. In some embodiments, the fraud mitigation server 850 acts as a gatekeeper between a mobile computing device, such as 810a, and the menu/order server 820.

By way of example, when a customer arrives at an establishment to order one or more items, the customer may use mobile computing device 810a to scan a QR code 815a that is displayed on a wall along a pick-up window queue. In some embodiments, the mobile computing device will transmit the MAC address of the device at the request of the WiFi security component 840. Contemporaneously with transmission of the MAC ID, the customer may be in the process of selecting one or more items to order. When ordering is completed, the customer may use a tool to transmit the order. The order would then be transmitted to the WiFi security component and then transmitted to the fraud mitigation server 850. In some embodiments, the fraud mitigation server 850 decides on a threshold distance from the tag which the mobile computing device 810a of the customer may be located in order to continue with the order. For instance, after ordering an item with the mobile computing device 810a, the customer may jump in a car to run an errand in a different part of town. When the order is received, the fraud mitigation server 850 of some embodiments directs the WiFi security component 840 to perform a proximity check against the MAC ID of the mobile computing device 810a. If the MAC ID cannot be detected, then the fraud mitigation server 850 will put the order on hold, because the mobile computing device 810a is outside the threshold range. On the other hand, if the customer walks into a neighboring store to run the errand, it is possible that the proximity check performed by the WiFi security component 840 will indicate that the customer is present. The fraud mitigation server 850 would then allow the order to proceed to the menu/order server 820 for processing. In this way, the fraud mitigation server 850 in combination with the WiFi security component 840 can reduce fraud and limit the number of needless charge-backs that credit companies often face.

In addition to the fraud mitigation and security features of the location-based ordering and fraud mitigation system 800, FIG. 8 also shows examples of different types of tags 815a-815n that can be scanned by a mobile computing device of a customer. Specifically, mobile computing device 810a scans a QR code tag 815a, mobile computing device 810b scans a bar code tag 815b, mobile computing device 810c scans a PDF417 tag 815c, and mobile computing device 810n scans an NFC tag 815n. A person skilled in the art would understand that the tags shown in this example is not an exhaustive list of the tags which can be used for scanning in the location-based ordering and fraud mitigation system 800.

While the invention has been described with reference to numerous specific details, one of ordinary skill in the art will recognize that the invention can be embodied in other specific forms without departing from the spirit of the invention. For instance, FIGS. 1, 4, and 5 conceptually illustrate processes in which the specific operations of each process may not be performed in the exact order shown and described. Specific operations may not be performed in one continuous series of operations, and different specific operations may be performed in different embodiments. Furthermore, each process could be implemented using several sub-processes, or as part of a larger macro process. Thus, one of ordinary skill in the art would understand that the invention is not to be limited by the foregoing illustrative details, but rather is to be defined by the appended claims.

I claim:

1. A location-based ordering system that provides a set of orderable items based on a scanned location encoding, the system comprising:
a tag that is positioned at a particular location of a venue, said tag comprising a location encoding that specifies the particular location of the venue;
a mobile computing device comprising an image capture device that scans the location encoding of the tag, a wireless receiver and transmitter that communicates with the venue from which items can be ordered, and a display screen that displays a menu associated with the venue, said menu comprising the set of orderable items;
a menu order item database that stores information to order the set of orderable items; and
a menu-order server that provides the menu to the mobile computing device and processes orders for items in the set of orderable items.

2. The system of claim 1 further comprising a WiFi security component that receives a MAC ID of the mobile computing device when the mobile computing device transmits a request for the menu to the venue.

3. The system of claim 2 further comprising a fraud mitigation server that directs the WiFi security component, upon receiving an order for an item from the mobile computing device, to determine whether the mobile computing device is within a threshold distance of the venue.

4. A non-transitory computer readable medium storing a program which when executed by at least one processing unit of a computing device scans a tag at a location of a venue to order an item from a menu associated with the venue, said program comprising sets of instructions for:
receiving a scan of tag comprising a data encoding associated with a venue and a location at the venue;
transmitting a request for a menu associated with the venue, said request comprising the data encoding;
receiving the menu associated with the venue, said menu comprising a set of menu items;
displaying the menu on a display screen of the computing device;
receiving a selection of a menu item to order from the set of menu items; and
transmitting an order for delivery of the selected menu item.

5. The non-transitory computer readable medium of claim 4, wherein the request further comprises a MAC ID associated with the computing device.

6. The non-transitory computer readable medium of claim 5, wherein the program further comprises a set of instructions for receiving a proximity validation request from a WiFi security component associated with the venue.

7. The non-transitory computer readable medium of claim 6, wherein the program further comprises a set of instructions transmitting the MAC ID to the WiFi security component to validate a present location of the computing device as being proximate to the venue.

8. A non-transitory computer readable medium storing a program which when executed by at least one processing unit of a computing device processes an order for an item, said program comprising sets of instructions for:
receiving a request for a menu and a tag location from a mobile computing device associated with a MAC ID, said menu associated with a venue and comprising a set of orderable menu items;
transmitting the menu to the mobile computing device;
receiving an order from the mobile computing device, said menu order comprising an order for a particular item in the set of orderable menu items;
identifying a location in a venue associated with the tag location; and
completing an order transaction for delivery of the particular item to the location in the venue.

9. The non-transitory computer readable medium of claim 8, wherein the program further comprises a set of instructions for performing a proximity check of the mobile computing device to determine whether the mobile computing device is within a threshold distance of the identified location of the venue.

10. The non-transitory computer readable medium of claim 9, wherein the program further comprises sets of instructions for:
transmitting a request for delivery of the particular item to the location in the venue when the mobile computing device is within the threshold distance of the identified location of the venue; and
waiting to transmit the request for delivery of the particular item to the location in the venue when the mobile computing device is not within the threshold distance of the identified location of the venue.
